(19) United States
(12) Patent Application Publication
(10) Pub. No.: US 2016/0099914 A1
(43) Pub. Date: Apr. 7, 2016

(54) DEVICE IDENTIFICATION IN A PICONET

(71) Applicant: ALCATEL-LUCENT CANADA INC., Ottawa (CA)

(72) Inventor: Adel HOUSSARI, Ottawa (CA)

(21) Appl. No.: 14/504,916

(22) Filed: Oct. 2, 2014

(51) Int. Cl. H04L 29/12; H04W 4/00

(52) U.S. Cl. CPC H04L 61/3005; H04W 4/008; H04L 61/3015

(57) ABSTRACT

An illustrative example device for communicating in a piconet includes a communication module configured to at least receive signals corresponding to a plurality of other devices, respectively. A first one of the signals indicates that a corresponding first one of the devices is capable of communicating in the piconet. A controller determines a first device name of the first device based on the first one of the signals and determines whether the first device name conflicts with a name of another device currently in the piconet. The controller modifies the first device name if the first device name conflicts with the name of the other device currently in the piconet and assigns the modified first device name to the first device for communications with the first device in the piconet.

### BACKGROUND

Piconets allow various user devices that are in close proximity to each other to communicate. Most piconets use the known Bluetooth communication protocol. Piconets are useful for a variety of situations, such as communicating among home electronics products or various mobile stations.

One challenge associated with managing communications in piconets is that the user devices are typically named by the user and there can be more than one device in the piconet with the same user-assigned device name. Even though the devices in the piconet may have unique 48-bit Bluetooth addresses, which are similar to the MAC addresses used in other networks to uniquely identify a device of the network, people do not easily utilize such addresses for identifying devices. Therefore, most piconets are configured to allow users to know which devices are in the network by recognizing the more user-friendly device names assigned by the corresponding users. While the individuals taking advantage of the piconet use the user-friendly name to address a device ultimately the Bluetooth address is used in actual communication.

The user-friendly or user assigned device name is configurable and the user can choose any words or phrase. The piconet devices translate between the user-friendly device names to the Bluetooth addresses. When two or more devices in a piconet have the same user-friendly or user assigned device name there may be confusion or a conflict when a communication is intended for or received from one of those devices.

### SUMMARY

An illustrative example device for communicating in a piconet includes a communication module configured to at least receive signals corresponding to a plurality of other devices, respectively. One of the signals indicates that a corresponding one of the devices is capable of communicating in the piconet. A controller determines a device name of the one device based on the one of the signals and determines whether the device name of the one device conflicts with a name of another device currently in the piconet. The controller modifies the device name of the one device if it conflicts with the name of the other device currently in the piconet and assigns the modified device name to the one device for communications with the one device in the piconet.

An illustrative example method of managing communications in a piconet includes determining a device name of one device that is capable of communicating in the piconet and determining whether the device name of the one device conflicts with a name of another device currently in the piconet. The device name of the one device is modified if it conflicts with the name of the other device currently in the piconet. The modified device name is assigned to the one device for communications with the one device in the piconet.

The various features and advantages of at least one disclosed embodiment will become apparent to those skilled in the art from the following detailed description. The drawings that accompany the detailed description can be briefly described as follows.

### BRIEF DESCRIPTION OF THE DRAWINGS

FIG. 1 schematically illustrates a piconet designed according to an embodiment of this invention.

FIG. 2 schematically illustrates selected features of a device designed according to an embodiment of this invention.

FIG. 3 is a flowchart diagram summarizing an example process designed according to an embodiment of this invention.

### DETAILED DESCRIPTION

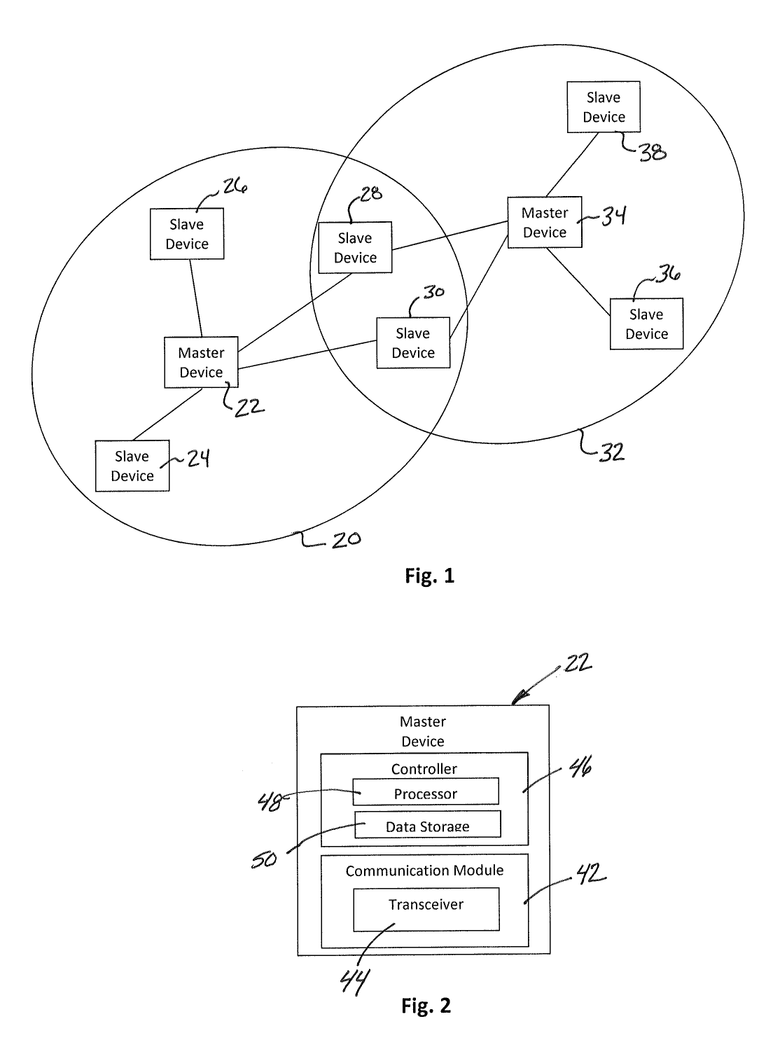

FIG. 1 schematically illustrates a piconet 20 that includes several devices. The piconet 20 includes a master device 22 and slave devices 24, 26, 28 and 30. Each of the devices 22-30 are capable of communicating within the piconet 20. FIG. 1 also shows a piconet 32 that includes a master device 34 and slave devices 28, 30, 36 and 38. All of the devices 28, 30, 34, 36 and 38 are capable of communicating within the piconet 32. The devices 28 and 30 are within both piconets 20 and 32.

The master devices 22 and 34 are referred to as master devices because they are the devices that control whether another device is included in their respective piconet and they manage the communications among the devices within their respective piconet. For example, the master devices 22 and 34 use known techniques to identify and admit the various devices into their respective piconets. The master devices 22 and 34 may be devices that have similar characteristics to the other devices within the piconet or they may be distinct from the other devices in the piconet. Those skilled in the art who have the benefit of this description will understand the types of devices that may serve as a piconet master device.

The example piconets may utilize known piconet communication techniques based on the known Bluetooth communication technology. Some embodiments of this invention include a piconet that includes other communication protocols such as a Zigbee protocol. Some example piconets will be limited to one master device and seven slave devices while others may have other limitations. It follows that the term “piconet” as used in this description and the appended claims need not be interpreted in the strictest sense but should be understood to include different embodiments of communication networks.

FIG. 2 schematically illustrates selected features of the master device 22, which are also features of the master device 34 in some embodiments. The master device 22 includes a communication module 42 configured for communications with the other devices in the piconet 20. The communication module 42 in this example comprises a transceiver 44 that is configured to at least receive signals corresponding to the other plurality of devices, respectively. Such signals may be used as part of a process of identifying potential piconet participant devices using known signaling techniques, for example. In some examples, the transceiver 44 of the communication module 42 is also used to transmit communications to the other devices in the piconet.

The master device 22 also includes a controller 46 associated with the communication module 42. The controller 46 in this example includes a digital processor 48 and digital data storage or memory 50. The processor 48 is configured to manage communications in the piconet 20, in part, by controlling the manner in which the devices of the piconet 20 are identified for purposes of communicating within the piconet 20. The controller 46 uses a technique of modifying device names when necessary to avoid conflicts or confusion between various devices within the piconet.

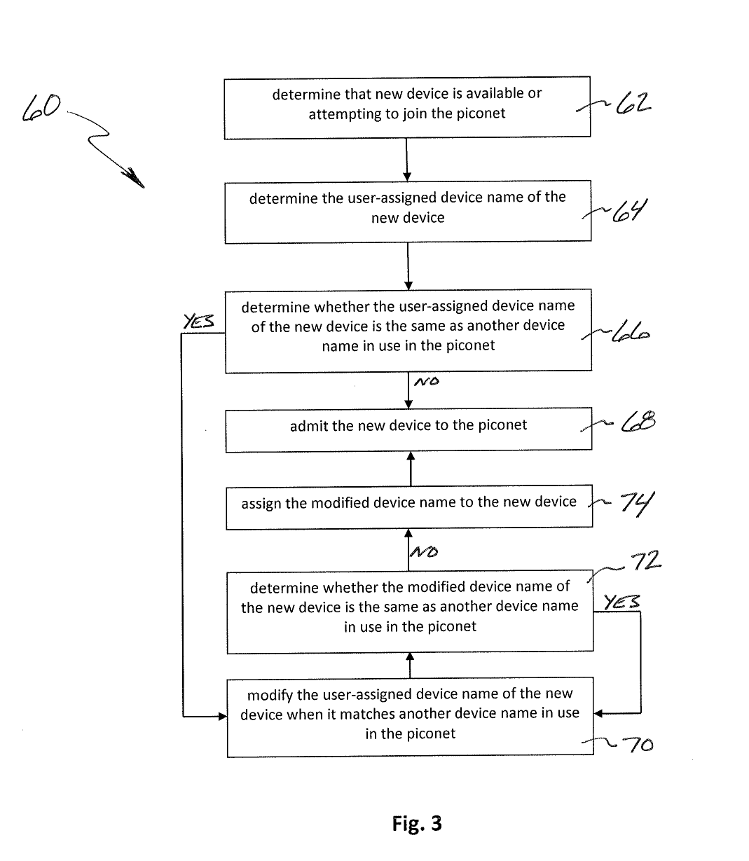

FIG. 3 is a flowchart diagram 60 that summarizes one example approach to managing communications within a piconet, such as the piconet 20. At 62 the controller 46 of the master device 22 determines that a new device is available or attempting to join the piconet 20. In some circumstances, the communication module 42 receives at least one signal from one of the devices 24-30 indicating that the device is trying to join the piconet. In other circumstances, the communication module 42 uses known polling techniques to discover devices within range of the piconet 20 for purposes of attempting to include such devices.

Assume that one of the signals received by the communication module 42 indicates that a user of a corresponding one of the devices 24-30 desires to join the piconet 20. For purposes of discussion assume that the devices 24, 26 and 28 are already in the piconet and that the device 30 is a candidate for joining the network. At 64, the master device 22 controller 46 determines the user-assigned device name of the device 30 based on information from the signal received by the communication module 42. At 66, the processor 48 of the controller 46 determines whether the user-assigned device name conflicts with a name of another device already in the piconet. In this example, there is a conflict when the user-assigned device name is the same as a name of another device currently in the piconet. In other words, the controller 46 determines whether the device name of the device 30 is the same as or otherwise conflicts with the device names of the devices 24, 26 or 28.

If the device name of the device 30 does not match the device names of any of the other devices currently in the piconet 20, then the controller 46 admits the device 30 to the piconet 20 at 68 and uses the device name to identify that device in the piconet.

If, on the other hand, the device name of the device 30 is the same as another device name in use in the piconet, the controller 46 modifies the device name of the device 30 as shown at 70. In some examples the controller 46 modifies the device name by appending at least one character to the device name. The appended character may be an alphabetic or numeric character. At 72, the controller 46 determines whether the modified device name conflicts with (e.g., is the same as) another device name in use in the piconet. If necessary, the controller will try another modified device name until one is obtained that is not the same as or otherwise does not conflict with any other device name in use in the piconet at that time. Once the controller 46 confirms that the modified device name is not currently in use for another device in the piconet, the controller assigns the modified name to the device 30 at 74.

That assigned, modified device name will be used to identify the device 30 for all communications within the piconet 20 at least until the device 30 leaves the piconet. Whether the device 30 will have a modified name if it later rejoins the piconet 20 will depend on the device names of the devices in the piconet 20 at that later time.

In this example, assigning the modified device name at 74 to a slave device includes pushing, sending or otherwise communicating the modified device name to that device. The slave device receiving the modified device name is configured to utilize the modified device name for all communications in the piconet until that device is released from or leaves the piconet

In the illustrated example, the digital data storage 50 includes a listing of the device names of the devices currently in the piconet. The listing will include the user-assigned device names if they were not modified and any assigned, modified device names that may have been instituted. If the device name of the device to be connected to the piconet does not exist in the listing or table in the memory 50 then

Given Device Name=Slave Device Name.

If the device name has to be modified in this example, the controller 46 adds a numeric character to the device name so that the assigned device name is described by

Given Device Name=Device Name+Sequence.

In this embodiment the sequence can be a number from 1 to 6 because this example is limited to a maximum of seven slave devices within the piconet. In one such embodiment the controller uses the numbers 1 through 6 in sequential order regardless of whether a device whose modified name included a lesser number in the sequence has recently disconnected from the piconet. In the event that the controller of the master device uses the number 6 as part of a modified device name it will attempt to use the number 1 for the next modified device name and continue to cycle through the numbers sequentially as needed.

The Given Device Name is temporary and valid for as long as that device remains in the piconet. The Given Device Name of every device in the piconet is unique compared to the Given Device Name of every other device in the piconet and valid while the device is connected to the piconet.

Consider the following example scenarios. If the connecting piconet device has a user-assigned name “Smart” and that name already belongs to another device currently connected the same piconet then the new connecting device shall have a new name, “Smart1.” Assume that another device has the device name “Smart.” When the controller of the master device 22 or 34 is admitting that device to the piconet, it modifies the device name with a different Sequence number. Under the circumstances described this far, the new device in the connecting stage with the device name “Smart” will be assigned the Given Device Name, “Smart2.” If another slave device is in the connecting stage and has the device name “Smart2” then the controller of the master device will modify that device name and the new Given Device Name shall be “Smart23.”

Referring to FIG. 1, the devices 28 and 30 belong to the two different piconets 20 and 32. It is possible for each of those devices to have two different Given Device Names for communications within the respective piconets. For example, Table 1 below represents the information in the digital data storage 50 of the controller 46 (except for the first column, which is included in Table 1 to relate the other information to the drawing). As shown in FIG. 1, the devices 24-30 are connected to the piconet 20 and the device 22 is the master device. The four connected piconet slave devices respectively have user-assigned device names Smart, Smart, Smart and Smart2. The controller 46 uses the technique described above and the resulting listing in the data storage 50 would be consistent with Table 1, for example. In this example, the devices are added to the piconet in the sequence indicated from top to bottom in Table 1.

TABLE 1

| | | Given | | | |
|---|---|---|---|---|---|
| | Device | Device | BlueTooth | | Additional |
| Device | Name | Name | Address | Type | Information |
| 24 | Smart | Smart | 10:9a:dd:25:40:6b | Smart | Connected |
| | | | | Phone | |
| 26 | Smart | Smart1 | 30:10:e4:26:42:da | Smart | Connected |
| | | | | Phone | |
| 28 | Smart | Smart2 | 30:11:e3:27:40:aa | Smart | Connected |
| | | | | Phone | |
| 30 | Smart2 | Smart23 | 31:12:d1:22:31:e1 | Smart | Connected |
| | | | | Phone | |

As can be appreciated from Table 1, the device 24 retains its user-assigned device name as its Given Device Name while the names of the other three devices were all modified by the controller 46. In the case of the device 30, the user-assigned device name “Smart2” is the same as the previously modified and assigned Given Device Name for the device 28 so that the controller 44 modified that name to be “Smart23.” In this example, the character (e.g., number) 3 is the next one in the sequence of characters used by the controller 46 for modifying device names.

The master device 34 maintains its own listing as shown in Table 2 in which the master device 34 has four connected slave devices 36, 38, 28 and 30. The devices 28 and 30 have the same user-assigned device names mentioned above and the devices 36 and 38 both have the device name “Smartc.” The connected table in the data storage of the master device 34 in this example is represented by Table 2, which includes an additional first column that would not be in the data storage listing but is included in Table 2 to relate the other information to that which is shown in FIG. 1.

TABLE 2

| | | Given | | | |
|---|---|---|---|---|---|
| | Device | Device | BlueTooth | | Additional |
| Device | Name | Name | Address | Type | Information |
| 36 | Smartc | Smartc | 10:9a:dd:25:40:6c | Smart | Connected |
| | | | | Phone | |
| 38 | Smartc | Smartc1 | 30:10:e4:26:42:db | Smart | Connected |
| | | | | Phone | |
| 28 | Smart | Smart | 30:11:e3:27:40:aa | Smart | Connected |
| | | | | Phone | |
| 30 | Smart2 | Smart2 | 31:12:d1:22:31:e1 | Smart | Connected |
| | | | | Phone | |

The devices joined the piconet in the order from top to bottom in Table 2. As can be appreciated from Table 2, the controller of the master device 34 modified the device name of the device 38 because it is the same as the device name of the device 36, which was already in the piconet when the device 38 joined. The controller of the master device 34 did not have to modify the user-assigned names of the devices 28 or 30 because neither of those matched the device name of any other devices currently in the piconet 32.

Comparing Table 1 to Table 2 reveals that the devices 28 and 30 each have a different Given Device Name in the piconet 20 compared to that in the piconet 32. This is not a problem because the respective master devices manage the communications within their respective piconet. Similarly, if the devices 28 and 30 had the same Given Device Name in more than one piconet that would not be problematic.

In this example all of the piconet devices maintain their own status table including their Given Device Name that was communicated by the corresponding master device. The following Tables 3-8 respectively correspond to the status table of the devices 24, 26, 28, 30, 36 and 38. The numbers in parentheses in the following tables would not be included in the information maintained by the devices but are included to show correspondence with the arrangement shown in FIG. 1.

TABLE 3
(Device 24)

| Device | Given Device | BlueTooth | | Master |
|---|---|---|---|---|
| Name | Name | Address | Piconet | Device |
| Smart | Smart | 10:9a:dd:25:40:6b | PicoOne | PicoOne |
| | | | (20) | (22) |

TABLE 4
(Device 26)

| Device | Given Device | BlueTooth | | Master |
|---|---|---|---|---|
| Name | Name | Address | Piconet | Device |
| Smart | Smart1 | 30:10:e4:26:42:da | PicoOne | PicoOne |
| | | | (20) | (22) |

TABLE 5
(Device 28)

| Device | Given Device | BlueTooth | | Master |
|---|---|---|---|---|
| Name | Name | Address | Piconet | Device |
| Smart | Smart2 | 30:11:e3:27:40:aa | PicoOne | PicoOne |
| | | | (20) | (22) |
| Smart | Smart | 30:11:e3:27:40:aa | PicoTwo | PicoTwo |
| | | | (32) | (34) |

TABLE 6
(Device 30)

| Device | Given Device | BlueTooth | | Master |
|---|---|---|---|---|
| Name | Name | Address | Piconet | Device |
| Smart2 | Smart23 | 31:12:d1:22:31:e1 | PicoOne | PicoOne |
| | | | (20) | (22) |
| Smart2 | Smart2 | 31:12:d1:22:31:e1 | PicoTwo | PicoTwo |
| | | | (32) | (34) |

TABLE 7
(Device 36)

| Device | Given Device | BlueTooth | | Master |
|---|---|---|---|---|
| Name | Name | Address | Piconet | Device |
| Smartc | Smartc | 10:9a:dd:25:40:6c | PicoTwo | PicoTwo |
| | | | (32) | (34) |

TABLE 8
(Device 38)

| Device | Given Device | BlueTooth | | Master |
|---|---|---|---|---|
| Name | Name | Address | Piconet | Device |
| Smartc | Smartc1 | 30:10:e4:26:42:db | PicoTwo | PicoTwo |
| | | | (32) | (34) |

When any of the devices are disconnected from a piconet the corresponding master connected table shall be updated including clearing the disconnected device's entry. The device's connected table will also be updated. If the master device is disconnected and another device becomes the new master device for a piconet, then all of the connected tables for all devices in the piconet will be cleared and the new master device will follow the approach described above to establish the names used for communications with the various devices in the piconet.

Various features and aspects of example devices and methods are described above. Embodiments of this invention may include less than all of the features described above or may include different or additional features. For example, Bluetooth communications are used in a described embodiment but other embodiments may include other communication protocols for communications within the piconet. Additionally, the schematically illustrated arrangements are shown that way for discussion purposes such that they should not be considered restrictive or limiting. For example, the schematic division of the controller 46 and the communication module 42 are for discussion purposes as the various functions and features of each may be realized through a single device or through more than two devices and different schemes for modifying user device names may be used.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

I claim:

1. A device for communicating in a piconet, comprising:
a communication module configured to at least receive signals corresponding to a plurality of other devices, respectively, at least one of the signals indicating that a corresponding one of the devices is capable of communicating in the piconet; and
a controller that
determines a device name of the one device based on the one of the signals;
determines whether the device name of the one device conflicts with a name of another device currently in the piconet;
modifies the device name of the one device if the device name of the one device conflicts with the name of another device currently in the piconet; and
assigns the modified device name to the one device for communications involving the one device in the piconet.

2. The device of claim 1, wherein
the controller maintains a listing of device names of all devices currently in the piconet; and
compares the device name of the one device to the names in the listing for determining whether the device name of the one device should be modified.

3. The device of claim 1, wherein the controller modifies the device name of the one device by appending at least one character to the device name of the one device.

4. The device of claim 1, wherein the controller
determines a second device name of a second device based on a second one of the signals;
determines whether the second device name conflicts with the name of another device currently in the piconet;
modifies the second device name if the second device name conflicts with the name of another device currently in the piconet; and
assigns the modified second device name to the second device for communications with the second device in the piconet.

5. The device of claim 4, wherein the controller
modifies the device name of the one device by appending a first character to the device name of the one device; and
modifies the second device name by appending a second character to the second device name.

6. The device of claim 5, wherein the second character is different than the first character.

7. The device of claim 4, wherein the controller determines whether the second device name conflicts with the name of another device currently in the piconet by determining whether the second device name is the same as another device name or a modified device name of another device in the piconet.

8. The device of claim 1, wherein the device is a master device of the piconet.

9. The device of claim 1, wherein the communication module is used to communicate the modified device name to the one device.

10. A method of managing communications in a piconet, comprising:
determining a device name of one device that is capable of communicating in the piconet;
determining whether the device name of the one device conflicts with a name of another device currently in the piconet;
modifying the device name of the one device if the device name of the one device conflicts with the name of another device currently in the piconet; and
assigning the modified device name to the one device for communications involving the one device in the piconet.

11. The method of claim 10, comprising
maintaining a listing of device names of all devices currently in the piconet; and
comparing the device name of the one device to the names in the listing for determining whether the device name of the one device should be modified.

12. The method of claim 10, comprising modifying the device name of the one device by appending at least one character to the device name of the one device.

13. The method of claim 10, comprising
determining a second device name of a second device that is capable of communicating in the piconet;
determinings whether the second device name conflicts with the name of another device currently in the piconet;
modifying the second device name if the second device name conflicts with the name of another device currently in the piconet; and
assigning the modified second device name to the second device for communications with the second device in the piconet.

14. The method of claim 13, comprising
modifying the device name of the one device by appending a first character to the device name of the one device; and
modifying the second device name by appending a second character to the second device name.

15. The method of claim 14, wherein the second character is different than the first character.

16. The method of claim 13, wherein determining whether the second device name conflicts with the name of another device currently in the piconet comprises determining whether the second device name is the same as another device name or a modified device name in the piconet.

17. The method of claim 10, wherein the determining, modifying and assigning are all done by a master device of the piconet.

18. The method of claim 10, comprising communicating the modified device name to the one device.

19. The method of claim 10, comprising using Bluetooth communications in the piconet.

20. A device for communicating in a piconet, comprising:
a communication module configured to transmit at least one signal indicating a device name of the device; and
a controller that uses one of the device name of the device or a modified device name received by the communication module for communications in the piconet, wherein the modified device name is received based on the device name conflicting with a name of another device currently in the piconet.
